(19) United States
(12) Patent Application Publication
(10) Pub. No.: US 2011/0161183 A1
(43) Pub. Date: Jun. 30, 2011

(54) SYSTEM AND METHOD FOR ADVERTISING AND SELLING PUBLISHED MATERIAL USING SOCIAL AND COMPUTER NETWORKS

(76) Inventor: Bernard Farkas, Herndon, VA (US)

(21) Appl. No.: 13/045,499

(22) Filed: Mar. 10, 2011

Related U.S. Application Data
(63) Continuation-in-part of application No. 12/795,234, filed on Jun. 7, 2010.
(60) Provisional application No. 61/185,394, filed on Jun. 9, 2009.

(51) Int. Cl. G06Q 30/00

(52) U.S. Cl. 705/14.73

(57) ABSTRACT

A series of text message units are created that follow the storyline of a fiction work, or in the case of a non-fiction work, a theme, philosophy, or set of facts. These message units are accessed upon selection of text that is annotated in an electronic document. Upon selection, the messages are transmitted via a computer network to a consumer, with the intent to create interest in the work. The website has the capability to act as a store and sell selected chapters of the final published work by virtue of computer to computer transfers. Further, the host store can sell the entire published work in a variety of methods including computer to computer downloads, or by delivery of tangible products such as print, portable computer readable memory elements or audio copies.

This application is a continuation-in-part of co-pending U.S. patent application Ser. No. 12/795,234, filed on Jun. 7, 2010, which claims the benefit of U.S. Provisional Application No. 61/185,394, filed Jun. 9, 2009, which are hereby incorporated by reference in their entireties.

### BACKGROUND OF THE INVENTION

The business of distributing fiction, non-fiction, and biographical stories is rapidly being limited because of ever increasing distribution and sales costs. As a consequence many excellent intellectual products are denied access to mass distribution outlets and are severely limited in their ability to reach their true audience potential. Accordingly, the publishing industry is losing revenue and the public is denied access to many valuable and entertaining intellectual achievements.

Needs exist for improved methods of advertising and selling stories to their intended audiences.

### SUMMARY

It is to be understood that both the following summary and the detailed description are exemplary and explanatory and are intended to provide further explanation of the invention as claimed. Neither the summary nor the description that follows in intended to define or limit the scope of the invention to the particular features mentioned in the summary or in the description.

In certain embodiments, the disclosed embodiments may include one or more of the features described herein.

“Computer network” as used herein encompasses any network of processor-based or computing devices, including tablet and other portable computers, PDAs, smart phones, cell phones, servers and electronic terminals of all kinds.

Opportunities to lower costs and increase the efficiency of advertising and selling books to their intended audiences are becoming more feasible as computer networking technological developments keep advancing, and more particularly as social networking increases in popularity and usage. The method embodied in this invention is made possible because of these new advancements and the growing popularity of social networking in particular, and computer networking in general.

In a new method of advertising stories, a series of short, plain text message units are created that follow the storyline and chapter layout of a published work. These message units are released by a host website into various social and/or computer networks on a set periodic sequence, hourly, daily or weekly, and can be viewed freely and for no cost by any network member, thus creating interest in the published work. Further, a data base of all previously released message units can be reviewed and/or retrieved by any network member at any time from the host website for no cost by a computer to computer connection.

The host website has the capability to act as a store and sell selected chapters of the final published work as well as the entire work, to network members or to other persons, by virtue of computer to computer transfers. The entire work in some embodiments is sold through the website by electronic download or physical fulfillment, and the price of a chapter is in some embodiments nominal and typically less than for the full work.

This method results in the creation of a plurality of segments made up of one or two short sentences which follow a prescribed sequence, herein after referred to as a “Bookclipz Story”, organized in a manner that parallels a full blown novel (or another type of intellectual property work). This type of document is not now created in the world of book publishing or in other allied fields, and can be a very important instrument in the book selling process and in selling other types of intellectual property. Book sales methods that are presently used include testimonial statements, extolling the reputation of the author, book signings by the author, TV appearances by the author, best selling lists, and critic reviews, to name the best of the presently used methods. These techniques work, but they are expensive and very limiting to the beginning author or small publisher.

The Bookclipz Story method entails, but is not limited to, the creation and distribution of the Bookclipz Story. The method works because of the Internet. Social networks are good sales targets because they present a viral, built-in audience. But, social networks are not the only way to deliver the Bookclipz story to potential audiences. For example, associations, schools, clubs, and business organizations provide other target computer networks that the Bookclipz Story method easily adapts to.

In one embodiment, the same bookclipz concept, with a variation, is used for non-fiction books, by organizing a series of short bursts of sentences with content from a particular non-fiction work. These bursts are limited to 140 characters in some embodiments for tweeting, and are not so limited in other embodiments. These snippets of information are put together in an ordered sequence, and when read together transmit a flow of thoughts, which follows important ideas or themes that are contained in the non-fiction work. This feature allows the user to better sample the work and is instilled the user with a greater confidence to buy the item.

This adaptation of a Bookclipz Story is used to sell a variety of non-fiction works, and a wide variety of other fiction or non-fiction intellectual property items: movies, magazines, audio tapes, patents, seminar reports, newspapers, etc.

The Bookclipz Story method is in some though not necessarily all respects analogous to making a trailer for a movie. It has been working for that market for over 70 years, with great results. The book world has nothing like it, but advances in distribution and communication technology now make possible the comparable but unique method of the Bookclipz Story. By providing tidbits or snippets from a book that parallel the overall story and book layout, titillating insights into the content of the book can be disseminated that go far beyond a table of contents or even a sample chapter.

A “text” refers to any written work such as a novel, book, magazine or scholarly article, etc., as well as spoken-word audio recordings.

These and other objects and features of the invention are apparent in the disclosure, which includes the above and ongoing written specification.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is a diagram of a text advertisement system.

FIG. 2 is a diagram of a text advertisement system.

FIG. 3 is a diagram of a text advertisement system.

### DETAILED DESCRIPTION

A system and method for advertising and selling published material using social and/or computer networks will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail.

### The Twitter Network (a Social Network Example)

The Twitter network is open to all people (followers) and allows them to access the website of a selected individual (the host) and read his or her message releases. A user may follow any number of hosts, those people who they find interesting for any of a variety of reasons. Accordingly, based on the attractiveness of the host, the network of host followers can encompass just a few people or range into the millions.

Presently, Twitter will accept any number of alias names. Accordingly, the host in some embodiments is given the same name as the product. For example, the Bookclipz Story for the book “Jaws” would be hosted by “Jaws”.

The host can release new information for his followers at any time, sometimes as frequently as three or four times a day. From a technical standpoint there are no real limits. However, the amount of information that is released to the network by any person at any one time, host or follower, is strictly limited to one hundred and forty characters (referred to as “tweets”), and every tweet message is tagged with the user name of the message writer. Further, any follower has the ability to post a tweet to the network for all to read and conversely any follower can receive direct messages from the host and any other person they follow. However the Twitter network makes no provision for any follower to send a direct tweet message to the host.

### Preparing the Advertisement

One embodiment of this invention starts with the chapters that encompass the text material of the work that is being prepared, or has been completed for sale. Using this material as a reference a writer creates the Advertisement, which consists of a plurality of short messages (hereafter called “Units”) that follow the sequence of the storyline and chapter layout of the product being offered for sale. Staying consistent with the current practices of social networking, the content of the Units may be written using a first person format, focusing on the view point of the main character of the story, or from a host story moderator. In the Twitter Network application, Units will be limited to one hundred and forty characters each and meet the standards of a tweet. For other social and/or computer networks, Units could encompass a character size larger than a tweet. For fictional works, each Unit advances the storyline of the work, and in nonfiction works, each Unit provides statements, facts or quotes from the book.

The Twitter network prefaces every Unit with the name of the host as the Unit message is processed into the Twitter network. For example, the name of the host might be Storyworkz, or Movie_Usher, or the title of the book. This “header” name is not part of the 140 character Twitter limit. Further, each Unit ends with a suitable URL website address that is created by the host, that is part of the 140 character limit established by Twitter, and connects the respondent back to a page designed to further the sales program setup by the host. In one embodiment, this URL transmits the respondent back to the section of the host website enabling the reader to view other Units in the Bookclipz Story.

The aggregate of all Units forms a body of work referred to as a Social and/or Computer Network Story (or a Bookclipz Story) and has a separate copyright.

### Basic Elements of a Bookclipz Story:

A Bookclipz Story, a copyrighted work, transforms the story line and chapter flow of a finished published work into a plurality of Units, which are released to the public in a time sequenced manner. In one embodiment, each Unit is prepared by a human editor using word processing software on a computer or by some other electronic text editing means. In an alternative embodiment, each Unit is prepared using an artificial-intelligence-based editing system programmed to select appropriate Bookclipz text from the original source material, for example, a media work. A media work may refer to works (either fiction or non-fiction) such as literary works and visual presentations that convey information in spoken or written words, numbers, or other verbal or numerical symbols. Examples of media works include, but are not limited to, books, magazines, journals, periodicals, and the like, movies, videos, lectures, flip chart presentations, slide shows, and other visual presentations.

A Unit may also be referred to equivalently as a Text Advertisement. Typically, the plurality of Units are created with an aim towards capturing some or all of the essential flow of the original source material, while still withholding significant details that a reader may be interested in learning more about.

The process of creating a Unit based on the original source material, and/or creating the plurality of units based on the original source material, is referred to herein as “parsing” the original source material.

The Units are stored in a digital format or other suitable format on a computer or similar storage device. The Units use the formats and standards established by the Internet and its network of affinity based organizations, including but not limited to social networks, associations, business and technical organizations, clubs, schools, hospitals, religious based affiliations, hobbyists and political movements.

In one embodiment, the Bookclipz Story has a word count limited to ten percent, or less, of the published media work, and is divided into more than one hundred Units. For example, a Bookclipz Story that follows a fifty thousand word novel could consist of five thousand words divided into one hundred Units, with each Unit containing as many as fifty words. Using a release rate of one Unit per day, the Bookclipz Story would be related to the public over a one hundred day period.

In an alternative embodiment, the Bookclipz Story may comprise a larger percentage of the total media work. In an alternative embodiment, the Bookclipz Story may comprise one hundred or fewer Units.

### Unit Sequence

### Example A

### A Fiction Story Inside the Tweet Template

The following is an example of five Units (or tweets) which apply to the first few chapters of a book, “3 Days of the Condor”, where the story content is inserted inside the 140 character space template provided by Twitter. In this example the network follower is referenced back to the registrant/host (the storyteller) of the Twitter account (for example “Movie_Usher”) by the header name attached to the Unit. The end section, starting with “http”, contains a link to the host website.

1. I am trained to notice small details and it bothered me when I saw an open window in our office townhouse http://stwz.us/?i=118
2. Because of the open window I checked the immediate area and every other thing seemed normal, so I decided to enter http://stwz.us/?i=119
3. My spine began to tingle and my neck felt cold when I failed to get any response to my three door bell rings hit http://stwz.us/?i=120
4. A strange odor attacked my senses when I entered the downstairs area and found it empty of people http://stwz.us/?i=121
5. My brain failed to register the fact that everybody was dead, brutally killed, as I moved from office to office http://stwz.us/?i=122

In some embodiments a different Bookclipz Story version for the same fiction work is created for use with other computer networks or for other sales applications, where the Unit size exceeds the 140 character limitation imposed by the Twitter Network. In this alternate case, the same Unit construction format as shown above is maintained. However, the story component for each unit is expanded in size, up to 300 or 400 characters, ending with a suitable URL website address.

### Unit Sequence

### Example B

### A Non-Fiction Bookclipz Story

The following is an example of three Units which apply to a non-fiction book where the Unit content shown in Example A now applies to a theme, philosophy, fact, disclosure or point of view portrayed in the non-fiction work, and has not been constructed to advertise a made up, plot driven story. The basic construction of the Unit for this use is the same as in Example A. The content part of the Unit can be altered in size to meet, or exceed, the character limitations of Twitter, with its size dependent on its intended usage. Again, like in Example A above, the Unit ends with a suitable URL website address.

1. Friedman started to lay the foundations of his career when he crossed the Atlantic in July 1918 and reported for duty with Military Intelligence at General Pershing's headquarters in France.
2. When the war ended in November of 1918, Friedman picked up a huge amount of practical knowledge about the ways in which codes—and to some extent ciphers—are used in the field.
3. After World War I Friedman and his wife went to work for the US Army, in Washington D.C. where they toiled away at the comparatively routine business of developing low-level codes.

### Organizing for Advertising and Selling the Product

In an embodiment, the establishment of an Internet website, containing three main functions, is the precursor to conducting a social network advertising and sales program for any published work product. These functions are described accordingly:

1. Unit/Chapter Repository: A computer-based or other processor-associated storage area, such as a hard drive, optical drive, flash drive, or similar, containing all Units and all plain text equivalents of the entire published media work. A data base of all previously released, and soon to be released, message units is maintained and network transfers are made to any computer designated by the Social and/or Computer Network or Store, or to any other source, at any time, by a computer to computer transfer.

2. Social and/or Computer Network Interface: A computer or other processor-based interface to register and maintain proper protocol with the different social networks and to maintain the periodic release schedule set by the website administrator for distributing Units for any given chapter.

These message units are released into various social and/or computer networks, including the Twitter Network, on a set periodic sequence which may be hourly, daily or weekly, and can be viewed freely and for no cost by any network member in order to create interest in the published work. The message units in some embodiments are released only on a website or on a website and through social networks. In some embodiments, all the message units are shown to a user in one viewing, creating an experience akin to a move trailer or Cliff notes. For example, all units may be made available on a website for a user to view prior to making a purchasing decision.

3. Store: A computer or other processor-based device with the capability to process valid orders and sell selected chapters of the final published work to network members or to other designated persons by virtue of computer to computer downloads. Further, the store can sell the entire published work in a variety of other methods by initiating an order to a fulfillment center for the delivery of tangible products such as print or audio copies. The price for selling individual chapters may have a nominal charge (less than a dollar). The price for the entire published work follows normal commercial rates, properly adjusted to meet market conditions for the different product delivery formats.

In an embodiment, an Internet server is programmed with software modules to carry out these functions. In an alternative embodiment, a computer or other processor-based device is coupled to the Internet/other data distribution network, and is programmed with software to carry out these functions. In an alternative embodiment, a distributed processing system is coupled to the Internet or other data distribution network, and is programmed with software to carry out these functions.

### Collateral Applications

The same advertising products and methods described in this invention can be used apart from social networks. Their application to the websites of publishers, retail outlets and distributors of written story products (novels, biographies, diaries, memoirs, etc.) adds interesting dynamics and customer traffic flow to their websites and provide the potential purchaser with an opportunity to advance sample the published material without expending the money to purchase the product. The process is analogous to the displaying of short movie trailers to prospective audiences for the purpose of gaining their interest in paying to view a feature film.

Further, the creation of a Bookclipz Story provides the owner of a published work with an important sales tool in selling individual book chapters using computer-to-computer transfers. This should raise the overall income level to the published work owner because it creates what many believe to be a viable new market

The text advertisements (Bookclipz) in various embodiments are transmitted into many different types of computer networks, covering a wide variety of purposes, including, but not limited to social networks, i.e., for business organizations, religion, education, science and technology, government, etc.

A text advertisement (Bookclipz) does not have to be transmitted into computer networks, other than by users accessing the text advertisements on a website, to have value. By providing a user complete access, in one viewing, to all of the Units of a text advertisement to the entire Bookclipz Story of the type described herein on a website or elsewhere, the user is provided with added insight enabling him or her to make a more informed judgment on ordering the product.

Text advertisements (Bookclipz) for a fiction work in many embodiments serves a different market than for a non-fiction work. In some embodiments the fiction work serves a general purpose, wide interest, audience. Hence it is transmitted into every type of computer network that it can be, i.e, social, business, school, religious, government, etc. On the other hand the non-fiction works advertisements in some embodiments need to be transmitted to those computer networks that serve a niche, specialty market, i.e, chemists, accountants, baseball coaches, music teachers, architects, patent attorneys, etc. In some embodiments the construction of the header and trailer (the protocol) of the text advertisement (Bookclipz) is altered to fit into a special type of computer network.

The non-fiction text advertisement (Bookclipz) in some embodiments contains facts, quotes, or opinions that are extracted from the Work without any modification. In some embodiments these terms are condensed, edited or synopsized.

FIG. 1 is a diagram of a text advertisement system 1. One or more Internet servers 3 have a computer storage area 5 configured to store a media work 7, a plurality of units of text advertisements adapted from the media work 11, and a database of released units 9. Internet servers 3 are programmed with a database maintenance software module 13 that maintains the database of released units 9, a network transfer software module 15 that performs network transfers from the computer storage area 5, and a social network interface software module 17 that is coupled with social networks 19 and distributes text advertisements 11 by transmitting them over social networks 19. One or more of the servers 3 is also programmed with an order processing and distribution software module 21 that processes orders and sells the media work by computer download or by initiating a fulfillment center order for delivery of tangible products.

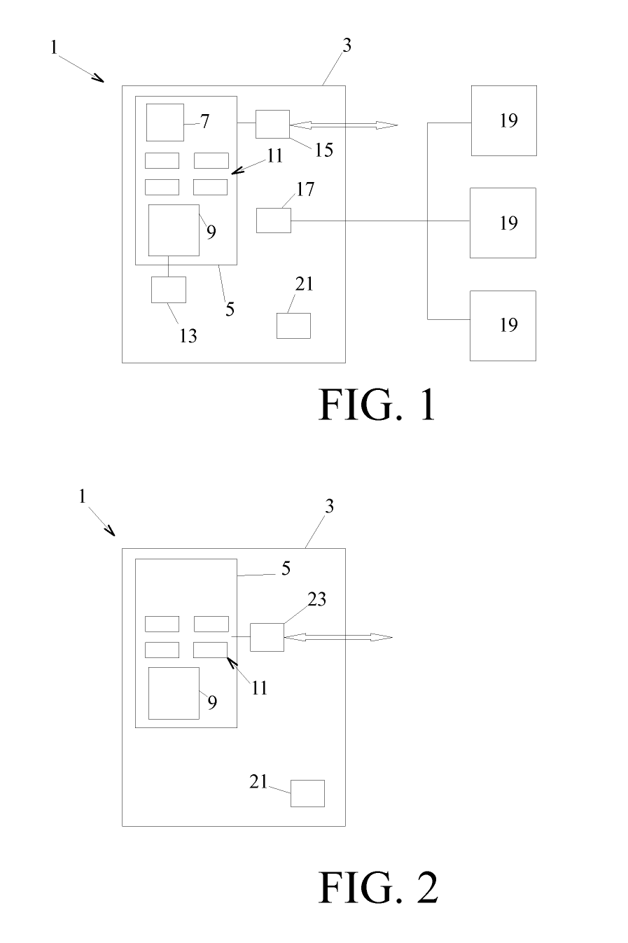

FIG. 2 is a diagram of a text advertisement system 1. One or more Internet servers 3 have a computer storage area 5 containing an advertising story divided into message units 11 that parallels the storyline of a literary work and a database 9 of released message units. One or more of the Internet servers 3 are programmed with a message unit release software module 23 that releases the message units 11 by transmitting them over the Internet or making them available for viewing or download over the Internet. One or more of the servers is also programmed with a store software module 21 that sells the media work or chapters of the media work over the Internet by download or initiating a fulfillment center order

### Annotated Electronic Books or Articles

The same advertising products and methods described in this invention may be extended for use with documents downloaded in electronic form (e.g., electronic books or articles) to a computing device (e.g., a computer, notebook, a tablet device, an e-book reader, and the like). In this case, predetermined words or phrases of the document may be annotated with hyperlinks. The hyperlinks may direct the user to a webpage containing more information relating to the hyperlinked words or phrases when clicked on by the user. In one embodiment, the link is to a Text Advertisement (Bookclipz) for a related book. For example, an e-book may contain the word “cryptography” that is displayed as a hyperlink. When selected, a web browser may be opened and display a web page (a “Bookclipz page”) containing one or more Text Advertisements (Bookclipz) for a nonfiction book about cryptography.

The Text Advertisement (Bookclipz) can include selected quotes/facts from a nonfiction book/text or visual presentation (e.g., a documentary; lecture, video, flip chart presentation, slide show, etc.), or a series of short narrative sentences that, when put together, tell a part or all of a general story of a fiction book (or other story, etc.). The Bookclipz page, in turn, is linked to the book/product from which they are drawn, thereby allowing the user to directly order the book or other products that the Text Advertisements (Bookclipz) pertain to.

### Detailed Example:

What follows is an example of a portion of an annotated text and accompanying Text Advertisements linked to from the text according to an embodiment of the present invention. The example annotated text in this case is an article, titled “Financing Your Early Stage Company”, a selection of which is given below. This article is annotated, turning the phrases “finance a startup business” and “startup entrepreneur” into hyperlinks (as indicated in the example annotated text by bolding and underlining).

The hyperlink for “finance a startup business” links to a Text Advertisement for a book called “Going Public”, and the hyperlink for “startup entrepreneur” links to a Text Advertisement for a book called “Xerox, the Billions Nobody Wanted”, with series of short narrative sentences telling part of the stories of the boOks. In the examples, a few such sentences are shown, however there may he any number of such sentences (or e.g. sentence fragments) telling any amount of the stories. Each Text Advertisement in this example also includes a one sentence introductory summary of the book's plot, the title of the book being advertised and the hyperlink that led to the Text Advertisement, and in some embodiments a method of purchasing the book would be included with each Text Advertisement. The books sold through the Text Advertisements in this example are of special interest to readers of the article, being related to themes of the article, and of special interest to those who click on the hyperlinks, indicating an interest in the pa theme with which each book is associated.

### Annotated Text Article:

### Financing Your Early Stage Company

Through the years it's always amazed me to see the different ways American entrepreneurs have used their ingenuity to find the resources to finance a startup business. There are certain traditional and obvious sources that everybody know about; banks, venture capitalists, angel investors, customer advances, collateral loans, strategic partnerships, friends and family. So, I′m not going to repeat what everybody knows.

Instead, I want to concentrate on the different types of precursor items that the successful startup entrepreneur needs to show or demonstrate before any type of financing can be best be secured. More than likely the nature of the item will lead to the source of the startup money.

### Subject Matter Expertise:

Being a leading expert in a specific field (Java programming, DNA research, etc), or possessing a high level professional educational degree (PHD in organic chemistry, medical school graduate, etc) are obviously very valuable attributes, but by themselves very hard to finance. Your best bet here is to build a nest egg through jobs, friends and family and then, down the road, open an office.

### Customer Following:

If you've built a loyal customer base through your past job performances you have overcome some major hurdles. The next step is to convert these accomplishments into contract orders. These orders will then drive you to number of financing sources dependent on the details of the order. Banks will finance certain types of contracts. Certain customers will provide you with advance deposits or progress payments. And, then there are always collateral loans and savings . . . .

### Text Advertisements (Bookclipz):

HYPER LINK: [finance a startup business]

### BOOKCLIPZ: Going Public

The true story of how the founder of a small startup company completed a public offering in spite of seemingly, insurmountable problems
1. My father, a stock market junkie, lived his life hoping to strike it rich in the stock market with penny stock.
2. I was 6 years old when he taught me how to read stock listings and track his “mining stock” portfolio
3. My father repeatedly said it was important to buy shares in a company before the “big boys”
4. I never knew who the “big boys” were exactly, but I knew they were evil guys who were up to no good
5. Later in life when I got older I met some real “big boys”, guys small in stature but large in stock holdings
   HYPERLINK: [startup entrepreneur]

### BOOKCLIPZ: Xerox, the Billions Nobody Wanted

A neophyte inventor embarks on a 25 year journey into the cold world of corporate politics and changes the way business is conducted
1. In 1934, US office workers fought a daily war using carbon paper, pencils, inks, pens and multilith masters
2. As a patent examiner, I taught myself how to write with both hands just to do my job
3. Writing all day long was unbearable, but the depression made jobs scarce, and I couldn't afford to quit
4. During lunch breaks I started to read old patents to find a better way to copy files and save my hands
5. The patent files in the 42^{nd} street library became my home as I looked for new ways to copy information
6. I became intrigued with electric photography, putting a charge on a piece of paper to be the shape of a letter

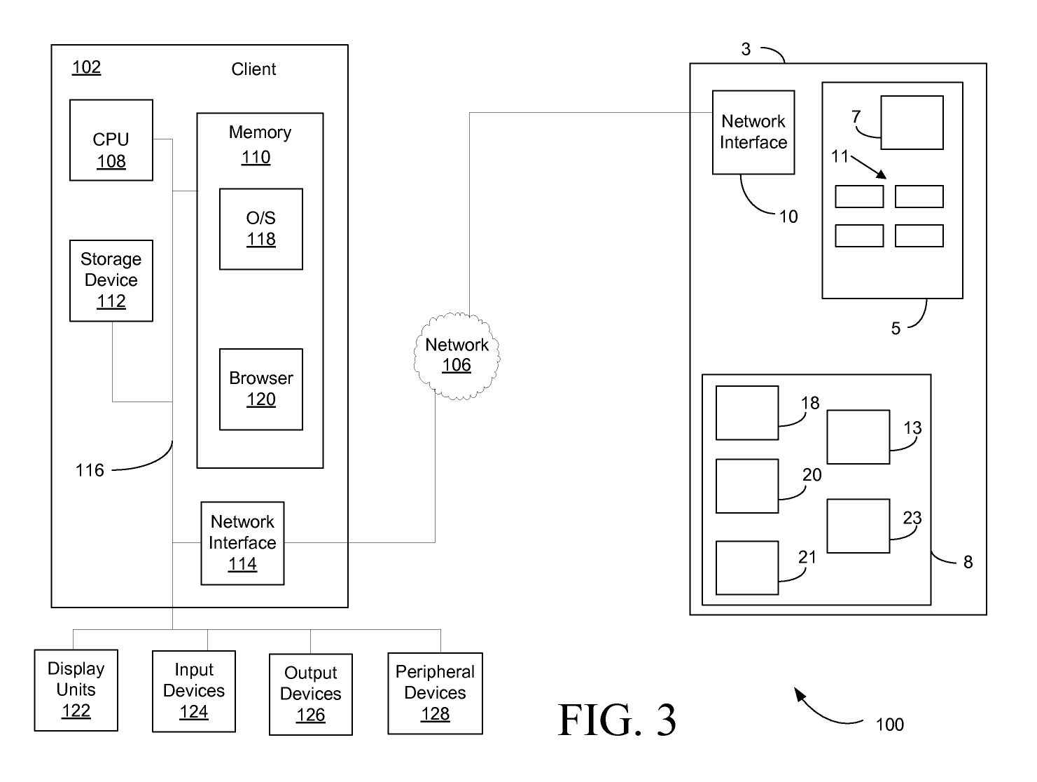

Turning now to FIG. 3, a block diagram illustrating an exemplary text advertisement system 100 including, in accordance with an embodiment of the present invention, is illustrated. In general, the text advertisement system 100 includes a client computer 102 (e.g., a desktop computer, a notebook, a tablet, an electronic-book (e-book) reader and the like) and one or more Internet servers 3. The client computer 102 and the Internet servers 3 may be components of the same computer system and/or may be connected via a network 106, such as the Internet, an intranet, a local area network (LAN) and/or the like.

As shown, the client computer 102 may include a central processing unit (CPU) 108 connected to a memory 110, a storage device 112, and a network interface 114 via a bus 116. The CPU 108 may be included to be representative of a single CPU, multiple CPUs, a single CPU having multiple processing cores, and/or the like. The storage device 112 may store application programs and/or data for use by the client computer 102. Examples of the storage device 112 may include one or more hard-disk drives, flash memory devices, optical media and/or the like. The client computer 102 may be connected to the data communications network 106 (e.g., a local area network (LAN), which itself may be connected to other networks such as the Internet) using the network interface 114. The memory 110 can be one memory device or a combination of memory devices, including a random access memory, a nonvolatile and/or backup memory (e.g., programmable or flash memories, read-only memories, etc.). Illustratively, the memory 110 of client computer 102 may store an operating system 118 that may be used to manage hardware and/or software executing on the client computer 102. As shown, memory 110 may also include a browser program 120 that, when executed by CPU 108, may provide support for navigating between various servers and/or locating network addresses at one or more servers (e.g., Internet servers 3). The browser program 120 may also display programs executed locally on the client computer 102. For example, the browser 120 may display a document (e.g., an electronic book) stored on the client computer 102 to a user. Moreover, as previously stated, the electronic book may be annotated to include words or phrases that are hyperlinked to webpages located on one or more servers (e.g., Internet servers 3).

The client computer 102 may be connected to one or more display units 122, input devices 124, output devices 126 and/or peripheral devices 128. The display units 122 may be internal and/or external monitors, television screens, handheld device displays, and/or the like. The input devices 124 may be any one of a keyboard, a mouse, a track-ball, a stylus, a mouse pad, a mouse button, a joystick, a scanner, a microphone and/or the like. The output devices 126 may be any one of a monitor, a printer, a plotter, a copier and/or any other output device. The peripheral devices 128 may be any other device that can be coupled to a computer: a CD/DVD drive capable of reading and/or writing to physical digital media, a USB device, a Zip Drive, an external floppy drive, an external hard drive, a phone and/or a broadband modem, a router/gateway, an access point and/or the like.

The one or more Internet servers 3 have a computer storage area 5, a memory 8, and a network interface device 10. The computer storage area 5 may store application programs and/or data for use by the client computer 102. Examples of the storage device 5 may include one or more hard-disk drives, flash memory devices, optical media and/or the like. The memory 8 can be one memory device or a combination of memory devices, including a random access memory, a nonvolatile and/or backup memory (e.g., programmable or flash memories, read-only memories, etc.). The Internet servers 3 may connect to the network 106 using the network interface device 10 (e.g., an analog modem, a wired network card, a wireless network device, and/or the like).

In one embodiment, the computer storage area 5 is configured to store a media work 7 and a plurality of units of Text Advertisements (Bookclipz) 11. As previously stated, the Text Advertisements (Bookclipz) 11 can include selected quotes/facts from a nonfiction book/text, visual presentations (e.g., a documentary, lecture, video, flip chart presentation, slide show, etc.), or a series of short narrative sentences that together tell a part or all of a general story of a fiction book. Internet servers 3 are programmed with a database maintenance software module 13 (located in the memory 8) that maintains the database of units. One or more of the servers 3 is also programmed with an order processing and distribution software module 21 that processes orders and sells the media work by computer download or by initiating a fulfillment center order for delivery of tangible products.

The memory also includes an http server 18, which responds to requests for access to electronic resources (e.g., HTML documents and/or other electronic documents) residing on the Internet servers 3. For example, the http server 18 may receive requests to receive Text Advertisements (Bookclipz) upon a user selecting an annotated text of an electronic document. In response, the http server 18 communicates with a message unit software module 23 that makes the Text Advertisements (Bookclipz) available for viewing (e.g., via the browser 120) and download over the Internet.

The invention is not limited to the particular embodiments described above in detail. Those skilled in the art will recognize that other arrangements could be devised, for example, using units containing excerpts of movie dialog or descriptions of movie actions to advertise movies, or using units containing lyrics to advertise music, applying the method/system to the sale of any intellectual property items, fiction or non-fiction, such as magazines, audio tapes, patents, seminar reports, court proceedings, biographies, newspapers, etc., using Units having different appearances and with or without identification numbers, etc., and using a differently configured or arranged website or using a downloaded/installed computer software program instead of a website to implement some of the disclosed functions. The invention encompasses every possible combination of the various features of each embodiment disclosed. While the invention has been described with reference to specific embodiments, modifications and variations of the invention may be constructed without departing from the scope of the invention.

I claim:

1. A method, comprising:
selecting annotated text in an electronic document stored on a processor-based device configured to transmit and receive data over a computer network; and
electronically receiving, using the processor-based device, a plurality of text advertisements over the computer network in response to selecting the annotated text,
wherein each of the plurality of text advertisements acts as a preview of a media work by providing a piece of the story of or information in the media work,
wherein the media work comprises subject matter related to the annotated text.

2. The method of claim 1, wherein the annotated text contains a hyperlink to a website containing the plurality of text advertisements,
wherein the website is linked to a product form associated with the plurality of text advertisements, and
wherein the product form is configured to allow a consumer to purchase the product.

3. The method of claim 1, wherein each of the plurality of text advertisements in the case of a fictional media work advances the story of the media work, and in the case of a nonfiction media work contains a fact or quote from the media work.

4. The method of claim 1, wherein the plurality of text advertisements for the media work parallels the media work and follows a storyline and layout of the media work.

5. The method of claim 1, wherein electronically receiving the plurality of text advertisements comprises receiving the text advertisement via a website for viewing over the computer network.

6. A system, comprising:
a processor; and
a memory containing a program, which when executed by the processor, is configured to perform an operation, the operation comprising:
selecting annotated text in an electronic document configured to transmit and receive data over a computer network; and
electronically receiving a plurality of text advertisements over the computer network in response to selecting the annotated text,
wherein each of the plurality of text advertisements acts as a preview of a media work by providing a piece of the story of or information in the media work,
wherein the media work comprises subject matter related to the annotated text.

7. The system of claim 6, wherein the annotated text contains a hyperlink to a website containing the plurality of text advertisements,
wherein the website is linked to a product form associated with the plurality of text advertisements, and
wherein the product form is configured to allow a consumer to purchase the product.

8. The method of claim 6, wherein each of the plurality of text advertisements in the case of a fictional media work advances the story of the media work, and in the case of a nonfiction media work contains a fact or quote from the media work.

9. The method of claim 6, wherein the plurality of text advertisements for the media work parallels the media work and follows a storyline and layout of the media work.

10. The method of claim 6, wherein electronically receiving the pluality of text advertisements comprises receiving the plurality of text advertisements via a website for viewing over the computer network.

11. A method, comprising:
receiving a request to transmit a plurality of text advertisements over a computer network; and
electronically transmitting, using a processor-based device, the plurality of text advertisements over the computer network in response to receiving the request,
wherein the request is initiated in response to a selection of an annotated text in an electronic document, and
wherein each of the plurality of text advertisements acts as a preview of a media work by providing a piece of the story of or information in the media work,
wherein the media work comprises subject matter related to the annotated text.

12. The method of claim 11, wherein the annotated text contains a hyperlink to a website containing the plurality of text advertisements,
wherein the website is linked to a product form associated with the plurality of text advertisements, and
wherein the product form is configured to allow a consumer to purchase the product.

13. The method of claim 11, wherein the media work is parsed to obtain and store the plurality of text advertisements, and
wherein each of the plurality of text advertisements is formatted for transmission over the computer network.

14. The method of claim 11, wherein each of the plurality of text advertisements in the case of a fictional media work advances the story of the media work, and in the case of a nonfiction media work contains a fact or quote from the media work.

15. The method of claim 11, wherein the plurality of text advertisements for the media work parallels the media work and follows a storyline and layout of the media work.

16. The method of claim 11, wherein electronically transmitting the plurality of text advertisements comprises making the text advertisement available on a website for viewing over the computer network.

17. A system, comprising:
a processor; and
a memory containing a program, which when executed by the processor, is configured to perform an operation, the operation comprising:
receiving a request to transmit plurality of text advertisements over a computer network; and
electronically transmitting the plurality of text advertisements over the computer network in response to receiving the request,
wherein the request is initiated in response to a selection of an annotated text in an electronic document, and
wherein each of the plurality of text advertisements acts as a preview of a media work by providing a piece of the story of or information in the media work,
wherein the media work comprises subject matter related to the annotated text.

18. The system of claim 17, wherein the annotated text contains a hyperlink to a website containing the plurality of text advertisements,
wherein the website is linked to a product form associated with the plurality of text advertisements, and
wherein the product form is configured to allow a consumer to purchase the product.

19. The system of claim 17, wherein the media work is parsed to obtain and store the plurality of text advertisements, and
wherein each of the plurality of text advertisements is formatted for transmission over the computer network.

20. The system of claim 17, wherein each of the plurality of text advertisements in the case of a fictional media work advances the story of the media work, and in the case of a nonfiction media work contains a fact or quote from the media work.

21. The system of claim 17, wherein the plurality of text advertisements for the media work parallels the media work and follows a storyline and layout of the media work.

22. The system of claim 17, wherein electronically transmitting the plurality of text advertisements comprises making the text advertisement available on a website for viewing over the computer network.
